(19) United States
(12) Patent Application Publication
(10) Pub. No.: US 2026/0320216 A1
(43) Pub. Date: Oct. 15, 2026

(54) BIOMETRIC AUTHENTICATION AND SECURE DATA RELEASE

(71) Applicant: Sidney Wilson, JR., Jackson, TN (US)

(72) Inventor: Sidney Wilson, JR., Jackson, TN (US)

(21) Appl. No.: 19/647,165

(22) Filed: Apr. 14, 2026

Related U.S. Application Data
(63) Continuation-in-part of application No. 19/288,251, filed on Aug. 1, 2025.
(60) Provisional application No. 63/834,713, filed on Apr. 14, 2025.

(51) Int. Cl. G06F 21/62; G06F 21/32

(52) U.S. Cl. CPC G06F 21/6218; G06F 21/32

(57) ABSTRACT

A system is provided for controlling access to protected data. The system includes a secure environment for storing the protected data, an authentication module that verifies an authentication input against a stored credential profile, a credential access control engine that grants or denies access based on the verification result, and a credential release module that releases the protected data upon receiving an affirmative access grant. The protected data can be released using a time-limited display operation or a single-use transmission operation to prevent persistent storage. The system also includes various features such as hardware-isolated secure storage, biometric fusion processing, security tier selection, ephemeral reveal engines, controlled output subsystems, duress response subsystems, and zero-knowledge proofs to enhance security and prevent unauthorized access.

### CROSS-REFERENCE TO RELATED APPLICATIONS

This application claims the benefit of priority of U.S. Provisional application 63/834,713, filed Apr. 14, 2025, and U.S. patent application Ser. No. 19/288,251, filed Aug. 1, 2025. The contents of the above referenced applications are incorporated in their entirety herein.

### BACKGROUND

Cryptocurrency security systems conventionally rely on static password authentication and single-modality security measures that create fundamental vulnerabilities in digital asset protection. Conventional hardware wallets and software-based cryptocurrency management systems typically employ fixed credentials that remain constant until manually changed by users, creating persistent attack vectors for malicious actors. Additionally, existing biometric authentication systems generally utilize single biometric modalities, which suffer from accuracy limitations, spoofing vulnerabilities, and insufficient security for high-value cryptocurrency transactions. The distributed nature of cryptocurrency networks has also created challenges in integrating with conventional financial infrastructure, limiting mainstream adoption and institutional-grade security implementations.

These conventional approaches suffer from several critical technical limitations that compromise cryptocurrency security and usability. Static password systems are inherently vulnerable to theft, interception, and coercion attacks, where users can be physically threatened to reveal their credentials. Single-point authentication failures create security weaknesses that can result in complete loss of cryptocurrency assets with no recovery mechanisms. Furthermore, the technical complexity and isolation of cryptocurrency systems from conventional banking infrastructure has created barriers to mainstream adoption, as users lack familiar institutional frameworks for secure storage and transaction processing. The absence of integrated multi-modal authentication systems and dynamic credential management has left cryptocurrency holders exposed to sophisticated attacks that exploit the permanent nature of conventional password-based security.

### TECHNICAL FIELD

Embodiments described herein generally relate to digital asset security, secure credential storage, and authentication systems, and in some embodiments, more specifically to physical blockchain security architectures and biometric authentication vault systems that control release of credentials, cryptographic material, or transaction authorization data using hardware-isolated devices.

### BRIEF DESCRIPTION OF THE SEVERAL VIEWS OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment and a system for physical blockchain security architecture, according to an embodiment.

FIG. 2 illustrates a flow diagram of an example of an authentication process for a physical blockchain security architecture, according to an embodiment.

FIG. 3 illustrates a flow diagram of an example of a biometric fusion process for a physical blockchain security architecture, according to an embodiment.

FIG. 4 illustrates a flow diagram of an example of a tiered security assessment process for a physical blockchain security architecture, according to an embodiment.

FIG. 5 illustrates a flow diagram of an example of a password generation and display process for a physical blockchain security architecture, according to an embodiment.

FIG. 6 illustrates an example of a method for physical blockchain security architecture, according to an embodiment.

FIG. 7A illustrates a front view of an example secure hardware device for a physical blockchain security architecture, according to an embodiment.

FIG. 7B illustrates a rear view of an example secure hardware device for a physical blockchain security architecture, according to an embodiment.

FIG. 8 is a block diagram illustrating an example of a machine upon which one or more embodiments may be implemented.

FIG. 9 illustrates a block diagram of an example vault, remote verification, and deployment architecture for a physical blockchain security architecture, according to an embodiment.

FIG. 10 illustrates a flow diagram of an example advanced protected-access workflow for a physical blockchain security architecture, according to an embodiment.

### DETAILED DESCRIPTION

Conventional credential protection, digital asset management, and identity verification systems suffer from multiple technical deficiencies. Many systems require a user to know, retain, and manually provide passwords, passphrases, seed phrases, or other credentials, thereby creating vulnerability to theft, phishing, coercion, and forced disclosure. Many systems further rely on network-connected infrastructure, cloud-based storage, or externally dependent authentication architectures, thereby increasing exposure to malware, remote compromise, unauthorized interception, and persistent credential leakage. Existing solutions also often lack flexible authentication scaling, controlled credential output, privacy-preserving verification, robust recovery mechanisms, and broad interoperability across institutional, consumer, and regulated environments. Embodiments described herein address these and other technical problems through a biometric authentication vault platform (e.g., BAY, etc.) that stores protected data in a secure environment and releases protected data only through controlled, time-limited, user-authenticated mechanisms. In various embodiments, the system is implemented using a standalone secure hardware device, an institution-managed storage architecture, a hybrid hardware/software platform, or combinations thereof.

In some embodiments, the system includes support for a broad range of biometric modalities. Such modalities may include fingerprint recognition using capacitive, optical, ultrasonic, or similar sensing; facial recognition using two-dimensional (2D) imaging, three-dimensional (3D) depth mapping, or structured light; iris recognition; retinal recognition; ocular recognition; voice recognition and voiceprint authentication; palm vein recognition; hand geometry recognition; ear shape recognition; behavioral biometrics such as keystroke timing, gesture analysis, mouse dynamics, or gait analysis; heartbeat or electrocardiogram (ECG)-derived signatures; thermal signatures; deoxyribonucleic acid (DNA)-based authentication; and other biometric or physiologically linked inputs, whether currently known or later developed. In some embodiments, one or more biometric modalities are abstracted into a protected feature space such that a common verification architecture can support newly introduced biometric inputs without fundamental redesign of the system.

In some embodiments, the system implements multi-factor and fusion authentication. A user may be authenticated using one or more biometric factors in combination with one or more additional factors, such as a personal identification number (PIN), a password, a passphrase, a challenge-response factor, a physical token, a near-field communication (NFC) credential, a smart card, a hardware key, an enrolled mobile device, or a wearable device. In some embodiments, multi-modal biometric fusion is performed simultaneously or sequentially, and the system generates an authentication confidence score based on weighted inputs from multiple biometric sources. In some embodiments, the system supports continuous or passive authentication during an authenticated session, liveness detection, anti-spoofing, challenge-response imaging, depth sensing, blink detection, thermal validation, and step-up authentication based on transaction sensitivity, credential classification, device context, or other risk conditions.

In some embodiments, the system uses a vault architecture that supports multiple storage models and protection methodologies. Protected data may be stored in encrypted on-device storage, encrypted off-device storage, encrypted cloud-based storage, hybrid local-and-cloud vaults, distributed storage, decentralized storage, or blockchain-anchored storage. In some embodiments, the system implements a secure enclave storage module in which encrypted credentials are stored in hardware-isolated memory regions and reconstructed only transiently within a protected execution context. In some embodiments, credentials, keys, or templates are fragmented across isolated memory segments or split across multiple storage locations such that no single region or location contains a complete plaintext version. In some embodiments, the system supports air-gapped vault access protocols, zero-knowledge proof authentication, biometric template revocation, biometric re-enrollment, biometric update workflows, hierarchical key derivation, split-key storage, and device-bound or user-bound key management.

In some embodiments, the system includes an access control and credentialing architecture that governs how protected assets are released, displayed, transmitted, delegated, and revoked. The system may provide biometric-gated access to documents, legal records, medical records, financial records, government records, enterprise secrets, identity credentials, digital wallets, secure packages, or other protected assets. In some embodiments, role-based access control is tied directly to biometric identity. In some embodiments, the system issues time-limited credentials, session-limited credentials, single-use credentials, revocable access tokens, or delegated access rights after successful authentication. In some embodiments, the system supports emergency override workflows, biometric recovery protocols, proxy access, multi-party authorization requiring two or more verified identities, graduated access levels based on confidence scores, and repeated-access prevention or unattended-access prevention policies.

In some embodiments, the system is adapted for sector-specific applications across legal, healthcare, financial services, real estate, government, law enforcement, enterprise, insurance, education, and personal security environments. In legal implementations, the system may be used for biometric electronic signatures, document execution, notarization, chain-of-custody, witness verification, or electronic discovery (eDiscovery) management. In healthcare implementations, the system may be used for patient identity verification, medical record access, prescription authorization, provider identity verification, or protected health information access. In financial implementations, the system may be used for account access, transaction authorization, wire confirmation, wallet protection, automated teller machine (ATM) access, or point-of-sale (POS) authorization. In real estate implementations, the system may be used for deed authentication, title workflows, escrow authorization, and closing execution. In governmental or law-enforcement implementations, the system may be used for identity credentialing, border control, secure facility access, evidence handling, or officer authentication. In enterprise implementations, the system may be used for facility entry, network access, privileged session control, build authorization, or secret release. In insurance, education, and personal security contexts, the system may likewise protect policy workflows, academic records, private archives, estate-planning vaults, digital asset storage, and secure recipient release functions.

In some embodiments, the system integrates with multiple device classes and hardware form factors. Such implementations may include a standalone hardware vault device (e.g., BAY, etc.), a biometric-enabled universal serial bus (USB) device, a dedicated hardware key, a mobile-device-integrated system using mobile operating system biometric application programming interfaces (APIs), a wearable-integrated system using smartwatches or biometric rings, an Internet of Things (IoT) device access controller, a vehicle or transportation access device, a smart home or smart building access device, a facility access appliance, an ATM integration, a POS integration, or an embedded enterprise credential appliance. In some embodiments, the same secure hardware device includes a visual display, physical input interface, biometric sensors, secure storage, secure processing circuitry, and controlled output hardware in a single portable form factor.

In some embodiments, the system further integrates biometric authentication with cryptographic and blockchain operations. A successful biometric verification event may enable release of cryptographic keys, unlock a key envelope, authorize a transaction signature, derive a key pair, or control access to a digital wallet or seed phrase. In some embodiments, the system supports biometric seed-phrase recovery, biometric-locked smart-contract execution, tokenized biometric identity, proof-of-personhood workflows, blockchain-anchored audit events, decentralized identity operations, and cryptographic binding of a biometric-authenticated state to a specific device, enclave, or hardware module. In some embodiments, the biometric event acts as an enabling condition for protected key release without requiring that raw biometric data itself be used directly as a cryptographic key.

In some embodiments, the system includes secure transmission and communication controls. The system may transmit authentication results, signed event records, authorization tokens, encrypted visual payloads, or policy-bound output data over secure communication channels. In some embodiments, the system supports end-to-end encryption, secure biometric communication channels, representational state transfer (REST)-based interfaces, GRAPHQL-based interfaces, software development kit (SDK) interfaces, API-based authentication delivery, secure enclaves, trusted execution environments (TEEs), attestation-backed sessions, and remote or virtual transaction verification. In some embodiments, the system notarizes electronic communications or digital records using cryptographically signed authentication event records associated with a biometric verification event.

In some embodiments, the system incorporates artificial intelligence (AI) and machine learning (ML) components. Such components may support adaptive biometric matching, anomaly detection, behavior-based identity baselining, continuous model improvement, federated learning, spoof detection, deepfake detection, liveness detection, and risk scoring. In some embodiments, behavioral baselines are established from interaction patterns, device handling, movement, timing, or navigation behavior and are used to supplement or validate identity. In some embodiments, model updates are generated locally and aggregated without disclosing raw biometric inputs, thereby preserving privacy while improving system performance.

In some embodiments, the system incorporates privacy and regulatory compliance architecture. Such architecture may implement biometric data minimization, consent capture, auditable consent trails, right-to-erasure workflows, template invalidation, deletion protocols, cross-border transfer restrictions, and jurisdiction-specific compliance profiles. In some embodiments, the system is configured to support or align with the Illinois Biometric Information Privacy Act (BIPA), the General Data Protection Regulation (GDPR), the California Consumer Privacy Act (CCPA), the Health Insurance Portability and Accountability Act (HIPAA), financial-sector privacy controls, or other regulatory frameworks. In some embodiments, the system stores only protected templates, encrypted features, hashed features, confidence values, or policy outputs rather than raw biometric images or recordings after transient processing is complete.

In some embodiments, the system includes audit, logging, and forensic capabilities. The system may generate tamper-resistant audit logs, cryptographically signed event records, timestamped authentication records, access history, output history, duress history, recovery history, and chain-of-custody records. In some embodiments, audit information is stored in append-only memory, write-once storage, encrypted logs, notarized records, or blockchain-anchored records. In some embodiments, the system supports forensic reconstruction of biometric authentication events, legal evidentiary review, eDiscovery workflows, anomaly alerting, unauthorized-access alerting, and real-time security event reporting.

In some embodiments, the system supports multiple platform, licensing, and deployment models. These may include software-as-a-service (SaaS) deployments, API-delivered biometric authentication, white-label enterprise authentication engines, SDK-based integration into third-party applications, subscription-based vault management, on-premise deployments, sovereign cloud deployments, hybrid cloud deployments, or private enterprise/government deployments. In some embodiments, a centralized management service distributes compliance profiles, firmware updates, reporting functions, policy updates, analytics, or enrollment workflows while preserving local credential control and secure release restrictions.

In some embodiments, the system includes one or more priority hardware and system-level subsystems. A secure enclave storage module may provide hardware-level isolated encrypted credential storage, credential fragmentation, memory isolation, no-plaintext-at-rest enforcement, and hardware attestation. A multi-factor biometric authentication system may provide per-vault configurable thresholds, integrated fingerprint scanning, ocular or facial recognition, optional thermal sensing, optional behavioral analysis, and dynamic escalation of required factors. A credential access control engine may evaluate confidence scoring, credential classification, time-based access rules, repeated-access prevention, and unattended-access prevention. An ephemeral reveal engine may provide timed self-clearing display of credentials, volatile-memory clearing, automatic lockout after reveal, configurable reveal windows, and tamper-interrupt behavior. A controlled output subsystem may provide a visual token output mode and a human interface device emulation mode with single-transmission enforcement, authenticated output selection, and mutual exclusion of simultaneous output channels. A duress and decoy response system may detect alternate authentication patterns, release a decoy vault, preserve real credentials, internally log the duress event, and optionally initiate a covert delayed notification. An offline recovery and legacy authorization module may support a protected physical recovery artifact, time-delayed authorization, inactivity-based authorization, legacy access workflows, multi-party confirmation, and full audit trails.

In some embodiments, the system further supports controlled document and data ingestion through imaging hardware that is also used for biometric capture. A camera or imaging subsystem used for facial, ocular, retinal, or liveness scanning may additionally be used to scan documents, labels, manifests, records, contracts, identifiers, or other source material that would be impractical to type manually. In some embodiments, scanned material is processed locally through image enhancement, optical character recognition (OCR), barcode recognition, quick response (QR) code recognition, or structured data extraction and is then associated with a vault, a delivery workflow, a recovery workflow, a transaction workflow, or another protected process. In some embodiments, such imaging functionality is performed locally without cloud dependence so that the scanned content remains within the protected environment of the device.

In some embodiments, the system also supports designated-recipient release workflows in which a protected record, package, vault, or shipment is bound to an enrolled biometric template of a designated recipient. A sender or authorized administrator may enroll, import, or duplicate an authorized protected biometric template and associate that protected biometric template with a package identifier, delivery event, vault identifier, or release policy. Upon delivery or attempted access, the system compares a presented biometric input against the bound protected biometric template and releases the protected content only when the presented biometric input satisfies the applicable threshold and any required liveness or contextual policy conditions. In some embodiments, this release workflow is performed entirely offline, and the system stores a cryptographically protected event record identifying the access attempt, the release decision, and associated policy conditions.

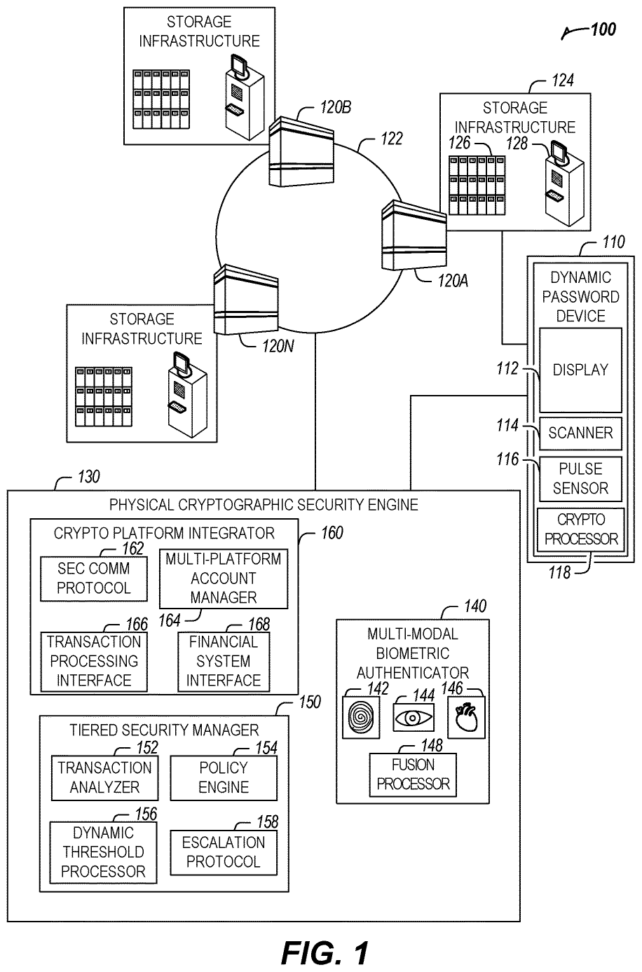

FIG. 1 is a block diagram of an example of an environment 100 and a system 130 for physical blockchain security architecture, according to an embodiment. A dynamic password manager device 110 is a compact hardware device that houses a temporal display 112, one or more scanners 114, one or more pulse sensors 116, and a secure cryptographic processor 118. In various embodiments, the scanner 114 may include a fingerprint scanner, retina scanner, ocular sensor, facial recognition sensor, depth sensor, camera subsystem, document-imaging sensor, or another biometric or imaging capture device. The pulse sensor 116 may include a heart rate sensor, electrocardiogram (ECG) sensor, thermal sensor, or another liveness or physiological sensing component. In some embodiments, the scanner 114 and the pulse sensor 116 cooperate to support multimodal biometric verification, liveness analysis, challenge-response imaging, document scanning, and policy-dependent step-up authentication. The dynamic password manager device 110 may also include a secure enclave storage module, credential fragmentation logic, tamper-resistant housing, fail-safe disablement circuitry, battery management circuitry, and one or more controlled output interfaces.

The dynamic password manager device 110 may be stored in one or more storage infrastructures 124. In the illustrated example, the storage infrastructures 124 are deployed at multiple storage locations 120A, 120B, and 120N, which are interconnected by a secure communication network 122. Each storage infrastructure 124 may include secure storage compartments 126 and one or more biometric access terminals 128. In an example, the storage infrastructure 124 is provided by a financial institution, secure vault facility, safe deposit environment, or another controlled storage location. The storage infrastructure 124 provides physical security and controlled access hours while permitting a user to retrieve, activate, or interface with the dynamic password manager device 110 in accordance with an access policy. In some embodiments, the distributed storage locations 120A, 120B, and 120N support redundancy, disaster recovery, backup device deployment, and geographically separated access continuity.

The dynamic password manager device 110 and the biometric access terminal 128 interact with the system 130. In the illustrated example, the system 130 is a physical cryptographic security engine. The system 130 includes a multi-modal biometric authenticator 140, a tiered security manager 150, and a crypto platform integrator 160. The multi-modal biometric authenticator 140 includes a fingerprint authenticator 142, a retinal or ocular authenticator 144, a heartbeat authenticator 146, and a fusion processor 148. The tiered security manager 150 includes a transaction analyzer 152, a policy engine 154, a dynamic threshold processor 156, and an escalation protocol 158. The crypto platform integrator 160 includes a secure communication protocol 162, a multi-platform account manager 164, a transaction processing interface 166, and a financial system interface 168. As shown in the parent drawings on page 1, these modules are logically grouped under the physical cryptographic security engine 130, with the distributed storage locations 120A, 120B, and 120N coupled through the secure communication network 122.

In some embodiments, the multi-modal biometric authenticator 140 performs multimodal biometric collection, biometric normalization, liveness detection, anti-spoofing analysis, confidence scoring, and generation of a unified authentication decision. In some embodiments, the tiered security manager 150 determines security requirements based on transaction amount, credential classification, destination system, location, time-based rule, user role, device state, or combinations thereof. In some embodiments, the crypto platform integrator 160 interfaces with cryptocurrency platforms, enterprise systems, legal or healthcare systems, remote relying applications, or other protected systems while preserving controlled release and policy enforcement. In some embodiments, high-level access control logic is distributed among the multi-modal biometric authenticator 140, the tiered security manager 150, and the crypto platform integrator 160 such that identity verification, policy selection, output authorization, and target-system interaction are coordinated but separately enforceable.

In some embodiments, the secure cryptographic processor 118 incorporates a dedicated hardware security module with embedded firmware specifically configured for secure key storage, dynamic password generation, credential release control, and secure boot. In some embodiments, the secure cryptographic processor 118 implements hierarchical key derivation, session-specific secret derivation, or time-based password generation while maintaining encrypted storage of authentication credentials. In some embodiments, the device 110 further implements a spliced key architecture in which portions of a secret, credential, or private key are stored in physically or logically distinct regions and reconstructed only transiently during an authorized access event.

In some embodiments, the dynamic password manager device 110 includes a secure enclave storage module that stores encrypted credentials or cryptographic material at rest and a credential access control engine that determines whether protected data may be reconstructed or released. In some embodiments, the secure enclave storage module fragments credentials across multiple isolated memory regions such that no single region contains a complete plaintext credential. In some embodiments, the credential access control engine evaluates authentication confidence, credential classification, transaction amount, requested operation type, time-based rules, historical behavior patterns, location data, device state, or combinations thereof.

In some embodiments, the dynamic password manager device 110 further includes an ephemeral reveal engine that controls the display of a password, token, credential, or other protected output on the temporal display 112. The ephemeral reveal engine may be configured to present the protected output for a configured time period, terminate display after expiration of a timeout, purge volatile memory and display buffers, and enforce re-authentication for any subsequent access event. In some embodiments, the dynamic password manager device 110 further includes a controlled output subsystem that provides a one-time visual token output mode, a one-time human interface device (HID) emulation mode, or another single-use output channel. In some embodiments, output channel selection is itself authenticated and only one output channel is permitted for a given access event.

In some embodiments, the system supports a duress and decoy response subsystem. The duress and decoy response subsystem may recognize an alternate biometric pattern, alternate sequence of factors, alternate finger, alternate eye, or other predefined duress trigger and, in response, provide access to a decoy credential vault rather than genuine protected credentials. In some embodiments, the decoy event is logged internally without producing an overt external alarm.

In some embodiments, the system supports an offline recovery and legacy authorization module. The recovery mechanism may use a physical recovery artifact, encrypted recovery key, recovery card, or secure token that can initiate a recovery workflow independent of primary biometric authentication. In some embodiments, recovery is conditioned on a secondary factor, a time delay, inactivity of a primary user, approval by multiple parties, or other predefined succession controls.

The secure storage compartments 126 may implement multi-layer physical security including environmental controls, alarm systems, tamper-evident seals, access logging, and monitored entry procedures. In some embodiments, multiple storage locations are strategically positioned in different geographic regions and interconnected through a secure encrypted wide-area network to support synchronization of backup credentials, device state, policy state, audit records, or recovery information. Such redundancy improves continuity when a device, storage location, or institution becomes unavailable.

A comprehensive audit trail system may record authentication attempts, password generation events, credential reveal events, selected output channels, transaction authorizations, recovery events, and duress events. The audit trail may be cryptographically protected and stored locally, remotely, or both, depending on embodiment.

Initial configuration and password setup for the dynamic password manager device 110 may be performed independently before the device is placed in a secure storage compartment 126. During setup, a user may configure biometric authentication requirements, select combinations of authentication factors, define transaction or credential sensitivity thresholds, establish time-based rules, define escalation requirements, configure reveal durations, select permissible output channels, and configure recovery or legacy authorization settings. The device may remain independent from a user's cryptocurrency accounts or external systems during some or all of the setup process.

The onboarding process may further include secure enrollment of biometric data and security preferences in a centralized or distributed management platform. In some embodiments, biometric templates, authentication policies, and user preferences are synchronized across multiple devices or storage locations in encrypted form. In some embodiments, privacy-preserving techniques, such as template protection or federated model updates, are used so that raw biometric data need not leave a protected device boundary.

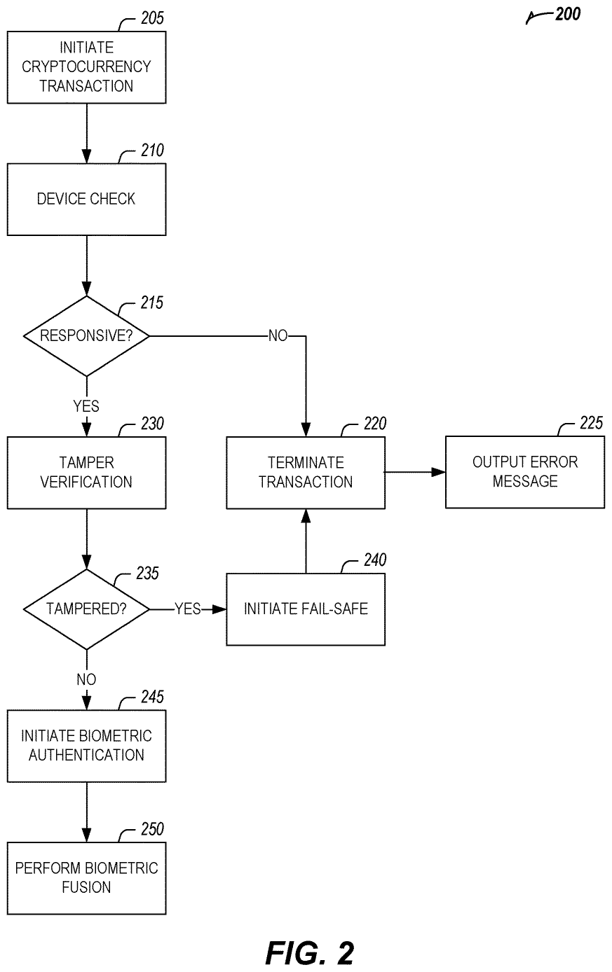

FIG. 2 illustrates a flow diagram of an example of an authentication process 200 for a physical blockchain security architecture, according to an embodiment. The authentication process 200 begins at operation 205 when a cryptocurrency transaction or protected access request is initiated. The request may include transaction parameters, access context, requested credential class, requested vault identifier, or other access information. At operation 210, a device check is performed to determine whether the dynamic password manager device 110 is present and responsive. At decision 215, if the device is not responsive, the process proceeds to operation 220 to terminate the transaction and then to operation 225 to output an error message. If the device is responsive, the process proceeds to operation 230 to perform tamper verification. At decision 235, if tampering is detected, the process proceeds to operation 240 to initiate fail-safe measures and then to operation 220. If tampering is not detected, the process proceeds to operation 245 to initiate biometric authentication, and then to operation 250 to perform biometric fusion.

In some embodiments, the fail-safe measures initiated at operation 240 include cryptographic key destruction, device disablement, memory erasure, secure lockout, alarm generation, audit log creation, or combinations thereof. In some embodiments, device presence and responsiveness at operation 210 include battery state verification, secure element health verification, enclave attestation, sensor availability checks, or combinations thereof.

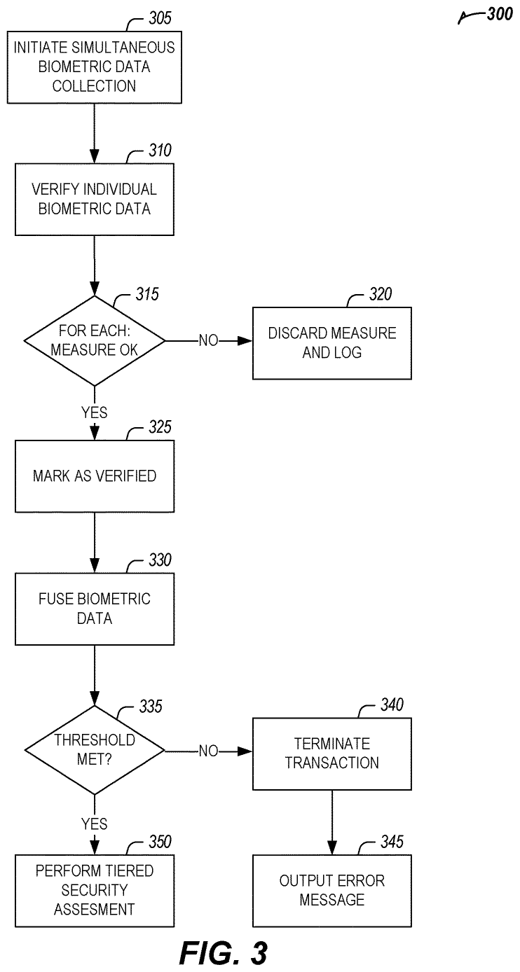

FIG. 3 illustrates a flow diagram of an example of a biometric fusion process 300 for a physical blockchain security architecture, according to an embodiment. As shown in the parent drawings on page 3, simultaneous biometric data collection is initiated at operation 305. At operation 310, individual biometric data is verified. At decision 315, the process determines for each collected measure whether the measure is valid. If a measure is invalid, the process proceeds to operation 320 to discard the measure and log the event. If a measure is valid, the process proceeds to operation 325 to mark the measure as verified. At operation 330, verified biometric data is fused. At decision 335, the process determines whether a threshold is met. If the threshold is not met, the process proceeds to operation 340 to terminate the transaction and operation 345 to output an error message. If the threshold is met, the process proceeds to operation 350 to perform tiered security assessment.

In some embodiments, operation 305 includes simultaneous or sequential collection of fingerprint, ocular, retinal, facial, thermal, heartbeat, electrocardiogram-derived, behavioral, voice, palm vein, hand geometry, gait, or other biometric inputs. In some embodiments, operation 310 includes modality-specific feature extraction, quality analysis, liveness analysis, and confidence scoring for each modality. In some embodiments, decision 315 evaluates whether each biometric measure satisfies a modality-specific validity threshold, quality threshold, spoof-resistance threshold, or liveness threshold.

In some embodiments, operation 330 is performed by the fusion processor 148, which combines biometric data from available modalities using weighted scoring, confidence thresholds, anti-spoofing measures, liveness checks, rule-based aggregation, machine learning classification, or combinations thereof. In some embodiments, the weighting assigned to a fingerprint signal, ocular signal, thermal signal, or behavioral signal is dynamically adjusted based on sensor quality, environmental conditions, requested credential sensitivity, transaction amount, target system, or historical user patterns. In some embodiments, decision 335 compares a unified authentication confidence score against a vault-specific or policy-specific threshold.

In some embodiments, operation 350 initiates step-up logic when the fused score is marginal, when an unusually high-risk request is detected, when a liveness signal is inconclusive, or when contextual conditions indicate elevated fraud or coercion risk. Step-up logic may require a second biometric modality, a stronger liveness challenge, an additional possession factor, a knowledge factor, or an administrative approval condition. In some embodiments, the process supports continuous or passive authentication after an initial threshold is satisfied by continuing to monitor one or more biometric or behavioral signals and revoking an authenticated state when subsequent confidence falls below a threshold.

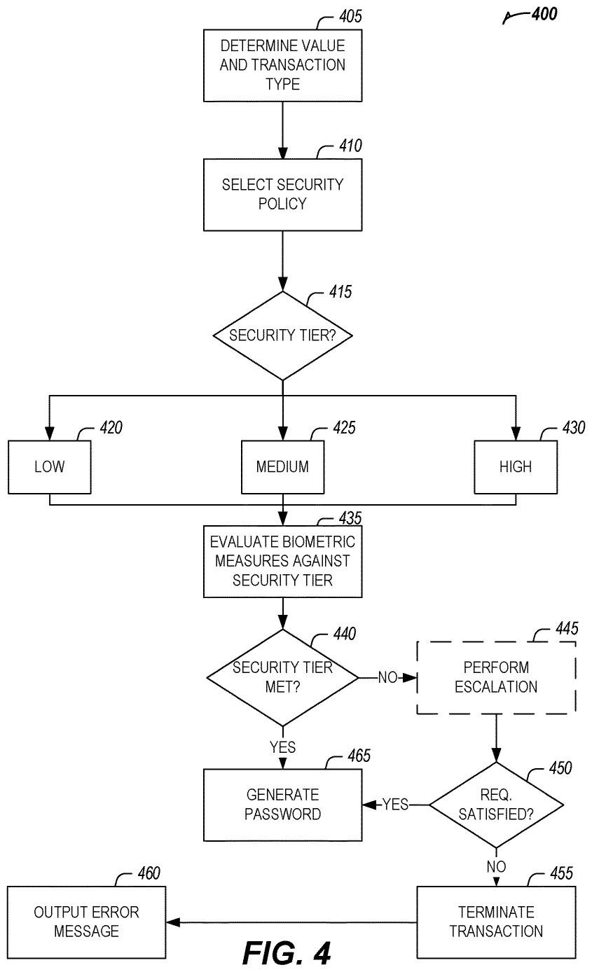

FIG. 4 illustrates a flow diagram of an example of a tiered security assessment process 400 for a physical blockchain security architecture, according to an embodiment. As shown in the parent drawings on page 4, the process begins at operation 405 by determining a value and transaction type. At operation 410, a security policy is selected. At decision 415, a security tier is determined. In the illustrated example, the tier may correspond to a low tier operation 420, a medium tier operation 425, or a high tier operation 430. At operation 435, biometric measures are evaluated against the selected security tier. At decision 440, it is determined whether the security tier requirements have been met. If the requirements have not been met, the process proceeds to operation 445 to perform escalation. At decision 450, if escalation requirements are not satisfied, the process proceeds to operation 455 to terminate the transaction and operation 460 to output an error message. If the security tier is satisfied, either directly at decision 440 or after escalation at decision 450, the process proceeds to operation 465 to generate a password.

In some embodiments, operation 405 includes determining a transaction amount, a transaction class, a credential classification, a destination category, a user role, a requested output type, a geographic location, a time-of-day condition, or combinations thereof. In some embodiments, operation 410 includes selecting a security policy from a policy set based on one or more of those parameters. In some embodiments, decision 415 selects among a plurality of security tiers corresponding to different required factors, different liveness burdens, different cooling-off delays, different output restrictions, or different approval requirements.

In some embodiments, the low tier operation 420 requires a single biometric match or another reduced factor set, the medium tier operation 425 requires multiple biometric factors or a biometric plus knowledge or possession factor, and the high tier operation 430 requires a comprehensive factor set, administrative approval, cooling-off delay, or both. In some embodiments, operation 435 compares authentication confidence, selected biometric modalities, liveness results, and contextual signals against the requirements of the selected tier. In some embodiments, decision 440 determines whether the current request satisfies both biometric requirements and policy-based access rules associated with the credential or operation.

In some embodiments, operation 445 performs risk-based escalation in response to a higher-value request, a higher-sensitivity credential classification, repeated access attempts, an unusual location, an unusual time, a new target device, an output request inconsistent with policy, or another elevated-risk condition. In some embodiments, decision 450 determines whether escalation requirements, such as additional biometric factors, a possession token, a delay interval, or supervisory approval, have been satisfied. In some embodiments, operation 455 terminates the request and may trigger lockout, enhanced audit logging, or alert generation. In some embodiments, operation 465 causes generation of a password, token, key release, or other protected output only after the applicable tier and any required escalation conditions have been satisfied.

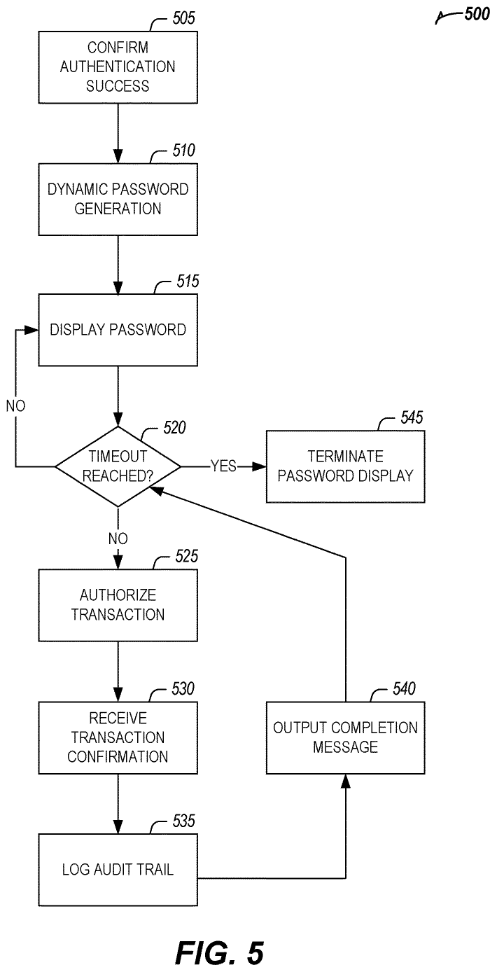

FIG. 5 illustrates a flow diagram of an example of a password generation and display process 500 for a physical blockchain security architecture, according to an embodiment. As shown in the parent drawings on page 5, the process begins at operation 505 by confirming authentication success. At operation 510, a dynamic password is generated. At operation 515, the password is displayed. At decision 520, it is determined whether a timeout has been reached. If the timeout has not been reached, the process may proceed to operation 525 to authorize a transaction, then to operation 530 to receive transaction confirmation, then to operation 535 to log an audit trail, and then to operation 540 to output a completion message. If the timeout is reached, the process proceeds to operation 545 to terminate password display. As shown in the drawing, the timeout decision 520 may be revisited during the display period and after transaction processing to ensure that display does not persist beyond the allowed interval.

In some embodiments, operation 510 is performed by the secure cryptographic processor 118 using time-based algorithms, hierarchical key derivation, session-specific cryptographic material, or combinations thereof. In some embodiments, operation 515 is implemented by the temporal display 112 under control of an ephemeral reveal engine. In some embodiments, operation 515 is limited to a predefined reveal interval that is configurable based on vault policy, credential classification, user role, requested output mode, or transaction sensitivity.

In some embodiments, decision 520 monitors expiration of the reveal interval, completion of a permitted output event, detection of user inactivity, tamper detection, capture attempts, or combinations thereof. In some embodiments, operation 525 authorizes a transaction, session, credential fill event, or other protected action only while the reveal interval remains valid. In some embodiments, operation 535 records an audit event identifying the reveal interval, the selected output mode, the associated credential class, and the associated transaction or target system. In some embodiments, operation 545 not only terminates the display but also clears volatile memory, clears display buffers, invalidates temporary reconstructed credentials, disables output channels, and enforces lockout pending renewed authentication.

In some embodiments, instead of or in addition to display, the protected output is delivered through a controlled output subsystem. The controlled output subsystem may generate a one-time encoded visual token for short-range capture by a local device, or may temporarily emulate a human interface device to deliver the credential or authorization data once to a target system. In some embodiments, no simultaneous multi-channel output is permitted. In some embodiments, no clipboard retention, persistent caching, or plaintext logging occurs during or after the output event. In some embodiments, an audit-triggered lockout is initiated when a timeout is exceeded, when a second output attempt is detected during a single access event, when an unauthorized capture attempt is detected, or when another policy violation occurs.

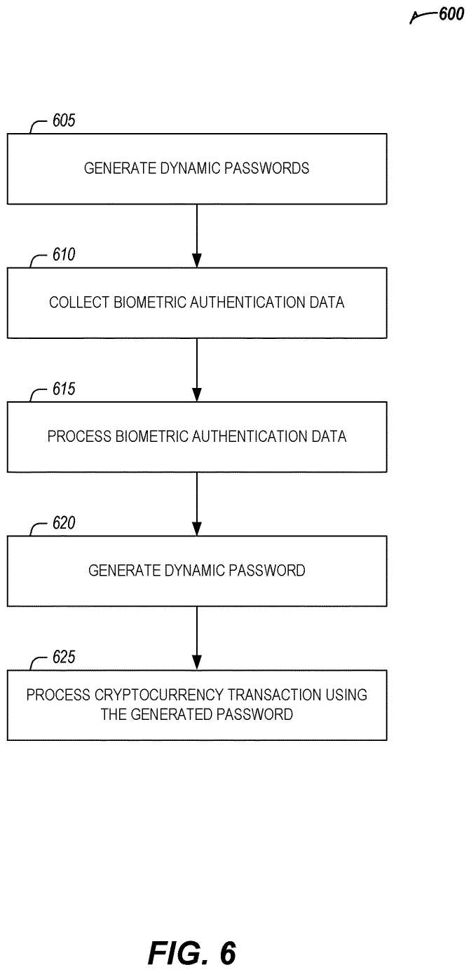

FIG. 6 illustrates an example of a method 600 for physical blockchain security architecture, according to an embodiment. At operation 605 the system generates dynamic passwords. At operation 610, the system collects biometric authentication data. At operation 615, the system processes biometric authentication data. At operation 620, the system generates a dynamic password. At operation 625, the system processes a cryptocurrency transaction using the generated password.

In some embodiments, operation 605 is performed by a secure cryptographic processor within a tamper-resistant hardware device while maintaining encrypted storage of authentication credentials. In some embodiments, operation 610 includes simultaneous collection from multiple integrated biometric sensors. In some embodiments, operation 615 includes execution by a biometric fusion processor using real-time algorithms to generate a unified authentication decision based on user-configurable security thresholds. In some embodiments, operation 620 includes displaying the generated password for a configurable time period before automatically hiding it. In some embodiments, operation 625 includes processing a cryptocurrency transaction via a secure communication protocol using the generated password. In other embodiments, the same method applies to non-cryptocurrency credentials, document access, remote login, enterprise privilege release, or other protected access events.

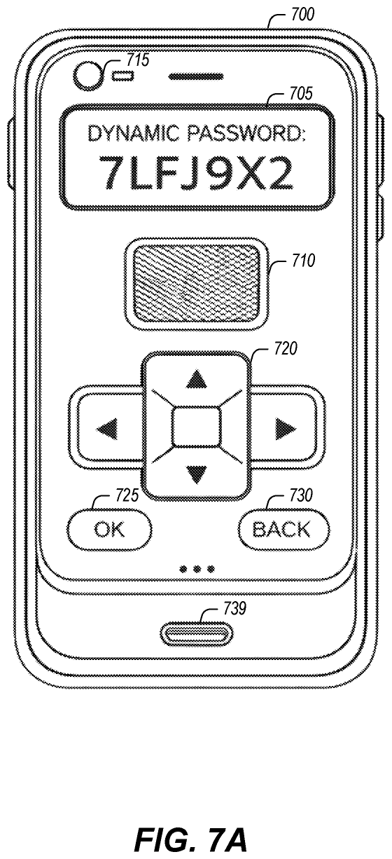

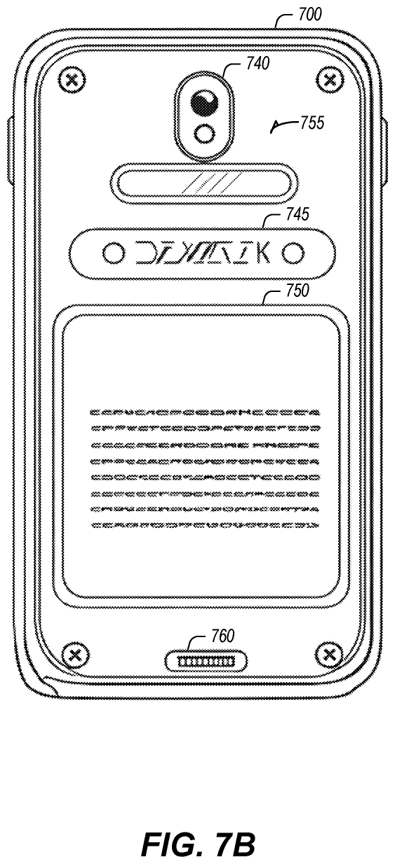

FIG. 7A illustrates a front view of an example secure hardware device 700 for a physical blockchain security architecture, according to an embodiment. In the illustrated embodiment, the front of the secure hardware device 700 includes a display device 705, an eye scanning sensor 710, a fingerprint scanning sensor 715, and a camera device 720. The display device 705 is configured to present a temporary password, expiration information, prompts, status information, or other output associated with device operation. In some embodiments, the display device 705 presents a generated password together with a countdown or remaining time-to-live value indicating how long the password remains valid or visible. The eye scanning sensor 710 may be configured to capture retinal, iris, ocular, or other eye-based biometric data for authentication. The fingerprint scanning sensor 715 is configured to capture fingerprint data for biometric verification. The camera device 720 may be configured to capture facial imagery, liveness data, challenge-response imagery, environmental context, or other visual data used in authentication or device security workflows. In some embodiments, the display device 705, the eye scanning sensor 710, the fingerprint scanning sensor 715, and the camera device 720 cooperate to support multi-modal biometric authentication and controlled presentation of dynamically generated passwords or other protected information.

FIG. 7B illustrates a rear view of an example secure hardware device 700 for a physical blockchain security architecture, according to an embodiment. In the illustrated embodiment, the rear of the secure hardware device 700 includes a keypad 730, a security level selection element 735, and a power, charging, and data transfer port 740. The keypad 730 may be implemented as a physical keypad, touch-sensitive keypad, or other user input interface, and may be used to enter numeric information, navigate menus, confirm prompts, cancel operations, or otherwise interact with the secure hardware device 700. The security level selection element 735 may be used to select among multiple security tiers, such as Tier 1, Tier 2, and Tier 3, corresponding to different authentication requirements or access conditions. In some embodiments, selection of a higher security tier causes the device to require additional biometric factors, additional liveness checks, or additional authorization conditions before releasing protected information. The power, charging, and data transfer port 740 may be implemented as a USB-C port or another wired interface and may be used for charging, docking, maintenance, controlled provisioning, or restricted data transfer consistent with device security policy. In some embodiments, the secure hardware device 700 includes an internal battery that is rechargeable through the port 740, and the device 700 may also be powered directly through the port 740 when docked in a secure storage facility or other controlled environment.

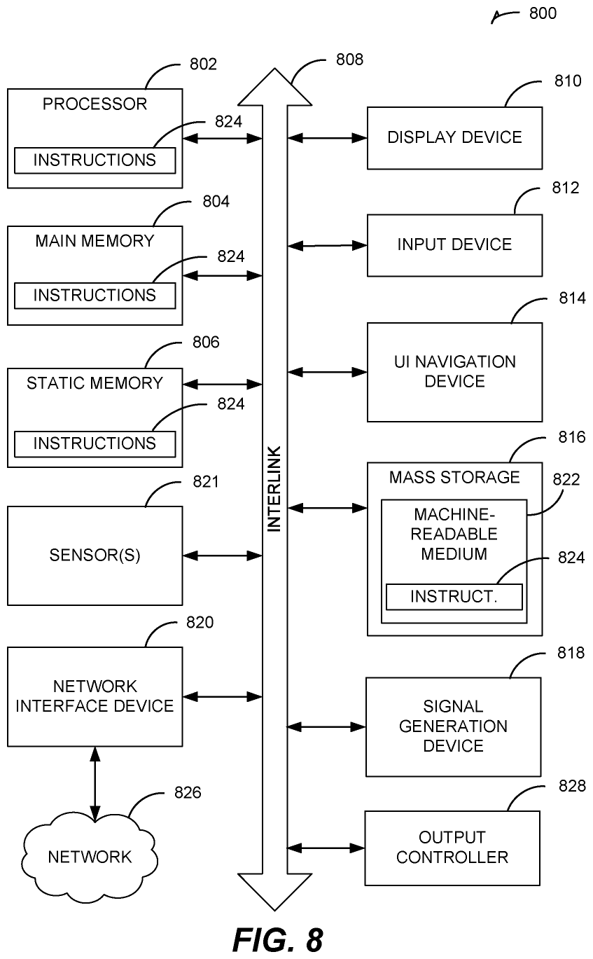

FIG. 8 illustrates a block diagram of an example machine 800 upon which any one or more of the techniques (e.g., methodologies) discussed herein may perform. In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine 800 (e.g., computer system) may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a display unit 810, an alphanumeric input device 812 (e.g., a keyboard), and a user interface (UI) navigation device 814 (e.g., a mouse). In an example, the display unit 810, alphanumeric input device 812, and UI navigation device 814 may be a touch screen display. The machine 800 may additionally include a storage device 816 (e.g., drive unit), a signal generation device 818 (e.g., a speaker), a network interface device 820, and one or more sensors 821, such as a global positioning system (GPS) sensor, compass, accelerometer, or other sensors. The machine 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 may constitute machine readable media.

While the machine readable medium 822 is illustrated as a single medium, the term “machine readable medium” may include a single medium or multiple media (e.g., a centralized or distributed database, and/or associated caches and servers) configured to store the instructions 824.

The term “machine readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine readable medium examples may include solid-state memories, and optical and magnetic media. In an example, machine readable media may exclude transitory propagating signals (e.g., non-transitory machine-readable storage media). Specific examples of non-transitory machine-readable storage media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, LoRa®/LoRaWAN® LPWAN standards, etc.), IEEE 802.15.4 family of standards, peer-to-peer (P2P) networks, 3^{rd} Generation Partnership Project (3GPP) standards for 4G and 5G wireless communication including: 3GPP Long-Term evolution (LTE) family of standards, 3GPP LTE Advanced family of standards, 3GPP LTE Advanced Pro family of standards, 3GPP New Radio (NR) family of standards, among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 800, and includes digital or analog communications signals or other intangible medium to facilitate communication of such software.

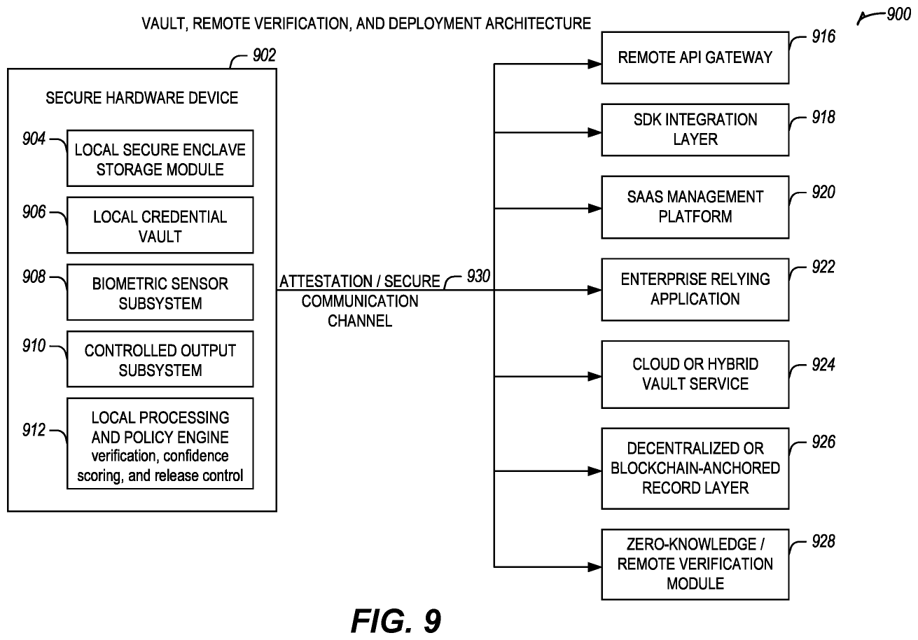

FIG. 9 illustrates a block diagram of an example vault, remote verification, and deployment architecture 900 for a physical blockchain security architecture, according to an embodiment. In the illustrated embodiment, the architecture 900 includes a secure hardware device 902 having a local secure enclave storage module 904, a local credential vault 906, a biometric sensor subsystem 908, a controlled output subsystem 910, and a local processing and policy engine 912. The secure hardware device 902 is communicatively coupled through an attestation and secure communication channel 930 to one or more remote or external service layers including a remote application programming interface (API) gateway 916, a software development kit (SDK) integration layer 918, a software-as-a-service (SaaS) management platform 920, an enterprise relying application 922, a cloud or hybrid vault service 924, a decentralized or blockchain-anchored record layer 926, and a zero-knowledge or remote verification module 928.

In some embodiments, the local secure enclave storage module 904 stores encrypted credentials, keys, templates, or other protected data in hardware-isolated storage, while the local credential vault 906 stores vault-specific records, credential metadata, or encrypted policy-bound protected data. In some embodiments, the biometric sensor subsystem 908 collects one or more biometric modalities, and the controlled output subsystem 910 controls generation of one-time outputs, visual tokens, or single-use transmission events. In some embodiments, the local processing and policy engine 912 performs local verification, policy evaluation, confidence scoring, output control, and release authorization without requiring routine cloud dependence.

In some embodiments, the attestation and secure communication channel 930 supports end-to-end encryption, device attestation, trusted execution, remote policy synchronization, or combinations thereof. In some embodiments, the remote API gateway 916 and the SDK integration layer 918 allow third-party systems to request biometric authentication, authorization tokens, or credential release events. In some embodiments, the SaaS management platform 920 distributes policy configurations, analytics, compliance profiles, and management functions. In some embodiments, the enterprise relying application 922 receives signed authorization results, time-limited credentials, or other protected outputs. In some embodiments, the cloud or hybrid vault service 924 stores encrypted remote vault data or escrowed protected data, the decentralized or blockchain-anchored record layer 926 stores notarized or append-only records, and the zero-knowledge or remote verification module 928 verifies satisfaction of an authentication condition without requiring transmission of raw biometric data.

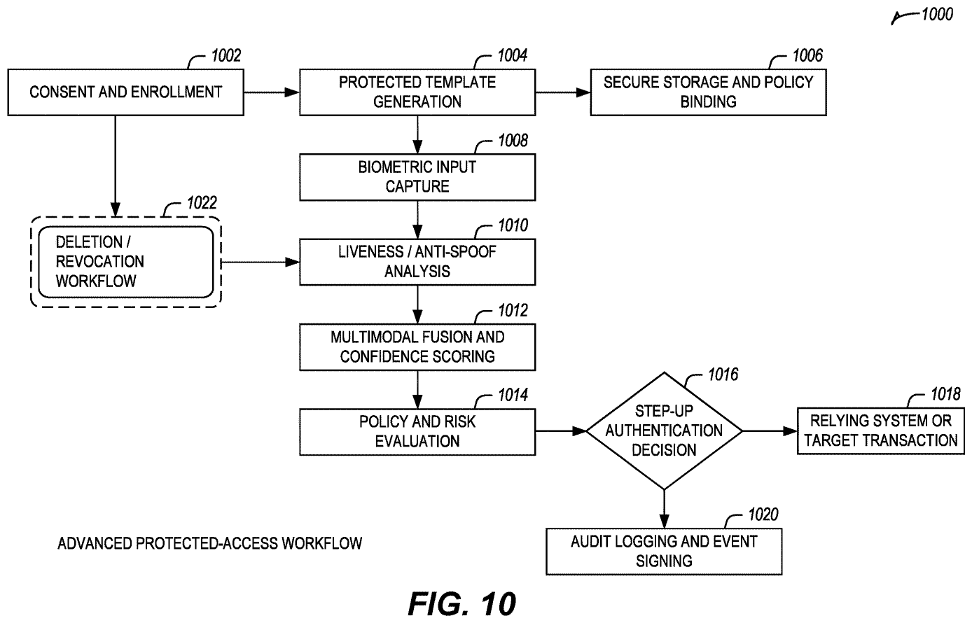

FIG. 10 illustrates a flow diagram of an example advanced protected-access workflow 1000 for a physical blockchain security architecture, according to an embodiment. In the illustrated embodiment, the workflow 1000 begins at operation 1002 with consent and enrollment. At operation 1004, a protected template is generated. At operation 1006, secure storage and policy binding are performed. At operation 1008, biometric input is captured. At operation 1010, liveness and anti-spoof analysis are performed. At operation 1012, multimodal fusion and confidence scoring are performed. At operation 1014, policy and risk evaluation are performed. At decision 1016, a step-up authentication determination is made. At operation 1018, credential release, token generation, or protected output authorization is performed for a relying system or target transaction. At operation 1020, audit logging and event signing are performed. At operation 1022, a deletion or revocation workflow may be invoked.

In some embodiments, operation 1002 includes capture of biometric consent, selection of permitted modalities, and jurisdiction-or policy-specific enrollment settings. In some embodiments, operation 1004 includes generation of protected biometric templates, encrypted feature sets, or noninvertible transformed biometric representations. In some embodiments, operation 1006 binds the protected template to one or more vault policies, credential classes, roles, delivery rules, recovery rules, or transaction parameters. In some embodiments, operation 1008 includes capture of one or more biometric inputs such as fingerprint, ocular, facial, thermal, behavioral, or other modality data.

In some embodiments, operation 1010 includes liveness analysis, anti-spoof analysis, challenge-response validation, depth analysis, or thermal verification. In some embodiments, operation 1012 includes weighted fusion, unified confidence scoring, and evaluation of modality-specific quality metrics. In some embodiments, operation 1014 includes policy-based risk analysis based on transaction amount, credential classification, user role, output type, time-based rule, or target system. In some embodiments, decision 1016 invokes additional authentication, an additional biometric modality, a possession factor, a knowledge factor, a delay interval, or an administrative approval step when applicable policy thresholds are not satisfied. In some embodiments, operation 1018 releases a time-limited credential, one-time token, transaction authorization, or controlled output event. In some embodiments, operation 1020 stores a signed audit record, and operation 1022 invalidates a protected template, deletes a stored association, or revokes a credential binding in response to a deletion request, a policy event, or an account change.

### Core Biometric Modalities

In some embodiments, the biometric authentication module 120 supports a broad set of biometric modalities including fingerprint recognition, facial recognition, depth-based facial recognition, iris recognition, retinal recognition, ocular vasculature recognition, voice recognition, palm vein recognition, hand geometry recognition, ear shape recognition, behavioral biometrics, gait analysis, heartbeat-derived signals, ECG-derived signatures, thermal signatures, or combinations thereof. Fingerprint recognition may be implemented using capacitive, optical, ultrasonic, or pressure-sensitive sensors. Facial recognition may be implemented using two-dimensional image capture, three-dimensional depth capture, structured light, time-of-flight sensing, or stereoscopic imaging. Iris or retinal recognition may be implemented using infrared imaging, visible-light imaging, vascular pattern extraction, or combinations thereof. Voice recognition may be implemented using voiceprints derived from spectral, temporal, phonetic, or prosodic features. Behavioral biometrics may include keystroke timing, dwell time, cursor trajectories, touchscreen gesture dynamics, device handling patterns, gait signatures, or combinations thereof.

In some embodiments, each biometric modality is associated with a modality-specific feature extraction pipeline that converts raw sensor data into protected biometric templates or feature vectors. In some embodiments, raw biometric data is processed locally within the device 110, within the biometric access terminal 128, within a trusted execution environment, or combinations thereof, and only protected templates, encrypted features, signed confidence scores, or combinations thereof are retained. In some embodiments, a template protection module applies cancelable biometric transforms, feature quantization, template hashing, encrypted embedding generation, or other noninvertible transformations before storage. In some embodiments, the system enrolls multiple reference templates for a single user under different operating conditions, such as varied lighting, partial occlusion, dry skin conditions, injuries, aging, or temporary physiological changes.

In some embodiments, emerging biometric modalities are supported through a modality abstraction layer that normalizes a newly available biometric input into a common confidence or feature interface usable by the fusion processor 148. This enables future biometric sensors or modality combinations to be incorporated without changing the overall credential access control architecture. In some embodiments, a newly introduced modality is paired with a calibration routine that establishes device-specific thresholds, liveness requirements, quality scores, and fallback behaviors.

### Multi-Factor and Fusion Authentication

In some embodiments, the system implements multi-factor authentication using one or more biometric factors in combination with a knowledge factor, a possession factor, or another contextual factor. A knowledge factor may include a password, PIN, passphrase, gesture pattern, or challenge-response answer. A possession factor may include a smart card, NFC token, hardware key, enrolled mobile device, secure wearable, recovery token, or cryptographic certificate. In some embodiments, the system performs multi-modal biometric fusion by collecting two or more biometric modalities simultaneously or sequentially and combining the resulting evidence using weighted scoring, rule-based thresholding, machine learning classification, or combinations thereof.

In some embodiments, the fusion processor 148 computes a unified authentication score from multiple modality-specific confidence scores and compares the unified authentication score to a vault-specific threshold. In some embodiments, the weighting of a fingerprint signal, ocular signal, thermal signal, or behavioral signal is dynamically adjusted based on sensor quality, environmental conditions, known spoof risk, requested credential sensitivity, or historical user behavior. In some embodiments, the system performs continuous or passive authentication by continuing to monitor one or more biometric or behavioral signals after an initial access grant and automatically revoking an authenticated state when confidence falls below a threshold.

In some embodiments, liveness detection is implemented using blink detection, pupil response, micro-movement analysis, thermal gradients, pulse detection, blood flow analysis, challenge-response image capture, acoustic challenge-response, movement synchronization, or combinations thereof. In some embodiments, the system performs step-up authentication when a requested operation involves a higher-value transfer, a higher sensitivity vault, a privileged credential, an unusual location, an unusual time, a new target device, or another elevated-risk context. Step-up authentication may require a second biometric modality, a stronger liveness challenge, a trusted token, administrator approval, a cooling-off delay, or combinations thereof.

### Vault Architecture and Storage

In some embodiments, the secure environment stores biometric templates, passwords, credentials, private keys, seed phrases, access tokens, or transaction authorization data in encrypted on-device storage within the secure enclave storage module 110. In some embodiments, the secure environment is implemented as an encrypted cloud vault, a hybrid local-and-cloud vault, a decentralized storage architecture, a blockchain-anchored metadata store, or combinations thereof. When cloud or remote storage is used, the system may store only encrypted fragments, sealed blobs, derived verification commitments, or other non-plaintext forms that cannot independently reconstruct a protected credential.

In some embodiments, the secure enclave storage module implements split-key storage by dividing a protected secret into multiple encrypted portions stored at different locations, such as within device memory, a secure facility, a remote cryptographic escrow service, or an enterprise key management system. In some embodiments, hierarchical key derivation is used to derive vault-specific encryption keys, credential-specific wrapping keys, device-bound keys, user-bound keys, or time-scoped session keys from one or more biometric-derived or hardware-rooted secrets. In some embodiments, the system verifies identity without transmitting raw biometric data by using zero-knowledge proofs, commitment schemes, challenge-response tokenization, secure enclaves, trusted execution environments, or combinations thereof.

In some embodiments, biometric template revocation, re-enrollment, update, or rotation is supported. A revocation event may invalidate one or more stored templates, derivation paths, or access bindings while preserving encrypted vault contents. Re-enrollment may require administrator approval, recovery token use, multi-party confirmation, or combinations thereof. In some embodiments, high-security deployments use an air-gapped vault access protocol in which sensitive decryption or credential reconstruction occurs only when the device is physically present within an approved environment and only after local policy verification.

### Access Control and Credentialing

In some embodiments, the credential access control engine enforces biometric-gated access to digital documents, healthcare records, financial records, government credentials, legal records, enterprise secrets, or other protected assets. The engine may associate each protected asset with a credential classification tier, time-based rule, role requirement, confidence threshold, geographic rule, device rule, output rule, or combinations thereof. Role-based access control may bind a user identity to one or more roles and permit access only when biometric verification confirms both the user's identity and the requested role context.

In some embodiments, the system issues time-limited access credentials or revocable access tokens following a successful biometric authentication event. A generated token may be valid for a single transaction, a single session, a fixed time period, a fixed target application, or a fixed target device. In some embodiments, multi-party authorization is required for access to designated vault contents or transaction approvals. Such authorization may require biometric verification by two or more users, biometric verification plus administrative co-signature, or biometric verification plus a delayed confirmation window.

In some embodiments, the system supports delegation of access rights, including proxy access on behalf of another authorized party. Delegated access may be time-limited, purpose-limited, location-limited, output-limited, or conditioned on dual consent. In some embodiments, graduated access levels are granted based on a biometric confidence score, such that a higher confidence result enables reveal of higher-sensitivity material while a lower confidence result permits only a limited operation. In some embodiments, emergency override workflows are supported for designated custodial or medical use cases, provided that all override actions are logged and optionally require subsequent reconciliation.

### Sector-Specific Applications

In some embodiments, the system is used in legal workflows to support biometric electronic signatures, execution of legal instruments, notarization processes, witness validation, litigation hold access, evidence chain-of-custody, eDiscovery access control, or combinations thereof. In one example legal workflow, a user physically retrieves the secure hardware device 700 from a secure storage infrastructure 124, authenticates using the fingerprint scanning sensor 710 and the ocular or optical recognition sensor 715, and selects a legal execution vault using the navigation control interface 720. The credential access control engine determines that a signing event requires a medium or high security tier, and the device releases a one-time signing credential for a limited duration on the display device 705 or through a controlled output channel. A cryptographically signed event record may be generated indicating the signer identity, date, time, document identifier, vault identifier, and selected biometric modalities. In some embodiments, a notary or witness performs a separate biometric confirmation so that the resulting audit record establishes a signing sequence and evidentiary chain of custody.

In some embodiments, the system is used in healthcare workflows to verify patient identity, control access to electronic medical records, authorize prescriptions, control release of protected health information, validate care-provider identity, or combinations thereof. In one example healthcare workflow, a clinician authenticates to the secure hardware device 700 using a fingerprint and facial or ocular scan before obtaining a limited-use credential for a prescribing platform. The device may output the credential through a HID emulation mode so that the credential is injected once into a prescribing workstation without exposing the credential in a persistent user-readable format. In another example, a patient authenticates biometrically before a protected record portal releases a session token permitting access to a designated record set for a limited duration. In some embodiments, a healthcare vault stores provider credentials, prescribing credentials, emergency break-glass credentials, or patient-linked access tokens subject to policy restrictions and logging rules.

In some embodiments, the system is used in financial services to authorize account access, wire transfers, cash movement, payment initiation, digital wallet access, institutional custody actions, cardless ATM access, point-of-sale authorization, or combinations thereof. In one example financial workflow, a user initiates a high-value transfer request, and the tiered security manager 150 requires a fingerprint scan, an ocular scan, and a pulse-derived liveness signal before the crypto platform integrator 160 or another financial platform interface releases a transaction authorization token. In another example, a user authenticates at an ATM or point-of-sale terminal, and the system provides a one-time credential or signed approval token over a local output path so that the transaction may proceed without exposing reusable account credentials. In some embodiments, the system associates transaction limits, geographic restrictions, time windows, or merchant controls with particular vaults or accounts.

In some embodiments, real estate applications include biometric confirmation of title document execution, deed authorization, escrow release, closing package authentication, or multi-party signing ceremonies. In one example real estate workflow, a buyer and a closing agent each authenticate biometrically, and the system releases a time-limited escrow authorization token only after both biometric confirmations are completed. In some embodiments, the system stores a cryptographically signed closing event record that identifies the signing parties, the property transaction identifier, and the timing of each authorization event.

In some embodiments, governmental or law-enforcement applications include border-control identity validation, secure facility entry, evidence locker access, officer credential validation, detainee identity confirmation, or combinations thereof. In one example governmental workflow, an officer authenticates with the secure hardware device 700 to obtain a time-limited facility access credential or case access token. In another example, evidence access requires two-party biometric confirmation so that retrieval of a sensitive record or physical evidence container is linked to a tamper-resistant audit log.

In some embodiments, enterprise applications include privileged network access, administrator session control, facility access, code-signing approval, deployment authorization, or secret release. In one example enterprise workflow, an administrator requests release of a production secret or privileged credential, and the system requires biometric authentication plus possession of an approved hardware token. The system may inject the secret once into a target endpoint through the controlled output subsystem 500 and may then terminate the reveal interval and require re-authentication for any subsequent action.

In some embodiments, insurance applications include policyholder identity validation, claims verification, adjuster access control, or settlement authorization. In one example insurance workflow, a claimant authenticates biometrically before the system releases a limited claims access token to a remote claims application. In another example, an adjuster and a supervisor each perform biometric confirmation before a settlement approval credential is released.

In some embodiments, education applications include transcript validation, diploma verification, examination access, testing session authorization, or academic credential release. In one example education workflow, a student or registrar authenticates biometrically to authorize release of an academic transcript, and the system creates a signed event record tied to the transcript request. In another example, a proctored examination terminal receives a one-time authorization token only after biometric verification of the examinee.

In some embodiments, personal security applications include access to password vaults, personal archives, family records, estate-planning vaults, secure package release, protected communications, or digital asset controls. In one example personal security workflow, a sender enrolls a designated recipient biometric profile in association with a secure package or protected digital record such that only the designated recipient may unlock the protected content using a matching biometric input. In another example, an estate-planning vault remains inaccessible during the lifetime of a primary user and becomes recoverable only after a defined inactivity period, multi-party confirmation, or a legacy authorization workflow. In a further example, the secure hardware device 700 is provisioned with a designated-recipient release policy for a shipment, courier delivery, secure parcel, or sealed container. During provisioning, a sender or authorized administrator enrolls a recipient fingerprint template, palm template, ocular template, or other recipient biometric template and binds the enrolled template to a specific vault, delivery identifier, package identifier, release event, or expiration condition. The enrolled recipient biometric template may be captured directly from the intended recipient, imported from a previously authorized enrollment record, or copied from a previously stored recipient biometric template under an authorized template-duplication policy. In some embodiments, the copied template is not stored as a raw image but instead as a protected template, encrypted feature set, or noninvertible transformed representation usable only for later match verification. Upon delivery, the secure hardware device 700 or an associated release terminal requests a biometric input from the person attempting to open the protected shipment. The credential access control engine compares the presented biometric input against the bound recipient template and releases the protected content, access credential, shipment unlock code, or vault contents only when the presented biometric input satisfies the applicable threshold and any required liveness conditions. If the presented biometric input fails verification, the protected content remains inaccessible and the event is logged. In some embodiments, the release workflow is performed entirely offline so that the package, device, or associated vault can be opened without network connectivity, cloud services, or third-party software, while still preserving a local cryptographically protected event record identifying the delivery attempt.

### Device and Hardware Integration

In some embodiments, the system integrates with mobile devices through mobile operating system biometric APIs, secure enclave frameworks, trusted execution modules, or device-bound key stores. The system may invoke a mobile device camera, fingerprint sensor, face recognition subsystem, secure element, or combinations thereof, while ensuring that protected outputs remain subject to vault policies. In some embodiments, the system integrates with wearable devices such as smartwatches, biometric rings, fitness bands, medical wearables, or secure badges that provide supplemental physiological or possession-based authentication evidence.

In some embodiments, the system controls access to IoT devices, smart home devices, vehicles, industrial systems, building entry systems, smart locks, kiosks, robotic systems, ATMs, or point-of-sale terminals. In some embodiments, the system is implemented in a standalone BAY hardware vault device, a biometric-enabled USB device, a dedicated hardware key, or an embedded credential vault module within another secure device. In some embodiments, the controlled output subsystem supports a one-time QR-based payload, a contactless token, a wired HID payload, a near-field communication transfer, or another secure local output path. In some embodiments, the system integrates with vehicular control systems or transportation access systems to allow biometric-gated ignition, route approval, operator login, or fleet credentialing.

### Cryptographic and Blockchain Integration

In some embodiments, the system derives cryptographic key pairs, vault keys, transaction authorization secrets, or session keys from one or more hardware-rooted secrets combined with biometric verification results. In some embodiments, a biometric event acts as an enabling condition for access to a seed phrase, recovery phrase, private key, signing key, or smart-contract control credential, without requiring that the raw biometric data itself be transformed directly into the key. In some embodiments, biometric confirmation unlocks or reconstructs a protected key envelope used for blockchain wallet operations, digital signatures, or transaction authorization.

In some embodiments, the system supports seed phrase recovery and protection for digital wallets. A seed phrase may be stored in encrypted fragmented form across multiple protected locations and reassembled only after satisfaction of recovery conditions. In some embodiments, a biometric authentication event authorizes execution of a smart contract, release of a tokenized identity, proof-of-personhood assertion, or decentralized identity operation. In some embodiments, the system binds a biometric-authenticated state to a specific device or secure module by cryptographically attesting that a successful authentication occurred on an approved hardware platform. In some embodiments, blockchain anchoring is used to record signed authentication events, timestamped audit markers, notarization hashes, access grants, or consent records without placing raw biometric data or plaintext credentials on-chain.

### Transmission and Communication Security

In some embodiments, the system transmits authentication signals, encrypted payloads, signed event records, or policy results over secure communication channels. Secure communication may include end-to-end encrypted transport, mutual authentication, attestation-backed session setup, short-range local encrypted channels, or combinations thereof. In some embodiments, the system exposes one or more application interfaces, including REST APIs, GraphQL APIs, messaging interfaces, event streams, or SDK bindings, for integration with external applications while preventing transmission of raw biometric data.

In some embodiments, remote or virtual transactions are supported by transmitting a signed biometric authentication result, a time-limited authorization token, a one-time visual token, or a device-bound proof of authentication to a relying system. In some embodiments, the system notarizes electronic communications, digital records, transaction requests, or execution events by generating cryptographically signed and timestamped authentication records linked to a biometric verification event. In some embodiments, biometric processing occurs within secure enclaves or trusted execution environments such that sensitive intermediate data remains isolated from the main operating system or host application.

### Artificial Intelligence and Machine Learning Components

In some embodiments, machine learning models are used to improve biometric matching accuracy, anomaly detection, liveness detection, credential access risk assessment, or combinations thereof. Adaptive biometric matching may use supervised, unsupervised, metric-learning, probabilistic, or neural network techniques to account for natural variation in a user's appearance or physiology over time. In some embodiments, the system establishes behavioral baselines for a user based on device interaction patterns, movement patterns, navigation patterns, access timing patterns, or combinations thereof, and evaluates deviations from such baselines during authentication.

In some embodiments, the system uses AI-driven anomaly detection to flag impersonation attempts, unusual access sequences, unusual output requests, atypical environmental conditions, unusual travel patterns, unusual target systems, or combinations thereof. In some embodiments, continuous model improvement is performed while preserving privacy through on-device learning, secure aggregation, federated learning, encrypted gradient sharing, or combinations thereof. In some embodiments, liveness detection and deepfake countermeasures are implemented using multimodal challenge-response, physiological consistency checks, temporal inconsistency analysis, spatial artifact detection, audio-video correlation, or combinations thereof.

In one example federated learning implementation, each secure hardware device 700 or each approved edge appliance computes local model updates from successful and unsuccessful authentication attempts without exporting raw biometric captures. A federated coordinator receives encrypted or masked parameter updates, aggregates the updates across a population of devices, and distributes an updated model that improves matching or spoof detection performance while preserving local privacy. In some embodiments, secure aggregation prevents the coordinator from learning any single device's raw update. In some embodiments, model updates are accepted only from attested devices operating approved firmware.

### Privacy and Regulatory Compliance Architecture

In some embodiments, the system implements a biometric data handling framework configured to comply with privacy laws, sector-specific regulations, contractual restrictions, or internal governance policies. The framework may include data minimization rules, consent capture workflows, retention schedules, cross-border transfer controls, deletion protocols, and auditability requirements. In some embodiments, the system stores only derived templates, hashed features, encrypted embeddings, confidence scores, or policy decisions necessary for authentication and does not retain raw biometric captures beyond a transient processing interval.

In some embodiments, a consent management subsystem records user consent to biometric enrollment, biometric use, delegated access, logging, recovery workflows, or combinations thereof. Such consent may be associated with timestamped records, cryptographic signatures, jurisdiction identifiers, data use scopes, or expiration dates. In some embodiments, the system supports right-to-erasure workflows, biometric data deletion protocols, template invalidation, and evidence of deletion. In some embodiments, cross-border transfer controls ensure that biometric or credential-related data remains within approved jurisdictions or is transmitted only in permitted protected form. In some embodiments, the system supports specific compliance profiles for BIPA, HIPAA, GDPR, CCPA, financial secrecy laws, law-enforcement retention policies, or enterprise governance rules.

In one example consent workflow, a user enrolls one or more biometric modalities through an enrollment interface and is presented with selectable consent scopes identifying the allowed purposes for biometric processing, the retention duration, the jurisdictions in which processing may occur, and whether delegated or recovery workflows are permitted. The user confirms one or more scopes using the secure hardware device 700, and the system stores a signed consent record linked to the enrolled user profile and vault policy set. In one example deletion workflow, the user requests deletion of one or more biometric templates or revocation of a vault binding, and the system invalidates the corresponding template records, deletes or cryptographically severs the corresponding stored references, updates audit records to indicate deletion completion, and prevents further use of the deleted template for authentication. In some embodiments, deletion may be immediate for local templates while remote encrypted fragments are queued for secure deletion and confirmed through a signed completion record.

### Audit, Logging, and Forensic Capabilities

In some embodiments, the system generates a tamper-resistant audit log for authentication attempts, access grants, denied requests, duress triggers, output selections, reveal intervals, transaction approvals, recovery workflows, policy changes, and administrative actions. An audit record may include timestamps, device identifiers, vault identifiers, selected biometric modalities, confidence scores, liveness status, output mode, target application identifiers, geolocation, or combinations thereof. In some embodiments, the audit record is digitally signed, hashed, chained to prior records, stored in write-once memory, stored in an append-only ledger, or anchored to a blockchain or notarization service.

In some embodiments, the system supports forensic reconstruction of authentication events for regulatory review, litigation, eDiscovery, chain-of-custody, dispute resolution, fraud analysis, or security investigations. In some embodiments, an investigator or authorized reviewer can reproduce an event timeline showing enrollment status, active policies, verified modalities, liveness results, reveal duration, selected output path, and whether a decoy or duress workflow occurred. In some embodiments, the system generates real-time alerts when an unauthorized access attempt, anomalous biometric event, tamper event, repeated access attempt, or suspicious output request is detected.

### Platform, Licensing, and Deployment Architecture

In some embodiments, the system is deployed as a software-as-a-service platform, a managed enterprise biometric authentication service, a white-label authentication engine, an SDK, an API service, an on-premise appliance, or a hybrid cloud-and-local deployment. In some embodiments, a centralized management service distributes policy configurations, firmware updates, compliance profiles, reporting dashboards, analytics, and enrollment workflows to a fleet of vault devices or integrated third-party applications.

In some embodiments, third-party applications invoke the system through a documented API or embedded SDK to request biometric authentication, credential release, authorization tokens, audit reports, or combinations thereof. In some embodiments, enterprise licensing supports multi-tenant operation, delegated administration, white-labeled branding, tenant-specific compliance profiles, and tenant-specific model configurations. In some embodiments, government or institutional deployments use private cloud, sovereign cloud, on-premise, or air-gapped variants of the system. In some embodiments, hybrid deployment permits biometric enrollment and audit administration in one environment while core credential storage and release remain local or hardware-isolated.

In one example API-delivered implementation, a relying application submits a signed authentication request identifying a target vault, target operation, target device, and requested output mode. The system evaluates policy, initiates biometric authentication on an approved secure hardware device 700, and returns either a signed denial record or a time-limited authorization token bound to the requested operation. In one example white-label deployment, an enterprise customer configures branded enrollment screens, custom policy tiers, tenant-specific compliance rules, and custom audit outputs while relying on the same underlying biometric vault and output control architecture.

### Core Hardware and System Components Priority Implementations

In some embodiments, the secure enclave storage module operates as a hardware-level isolated storage module for encrypted credential management. Credentials may be fragmented across isolated memory segments, encrypted under hardware-rooted keys, and made inaccessible to the main operating system, other applications, or untrusted firmware. Hardware attestation may be required before any credential reconstruction or release event. In some embodiments, credential reconstruction occurs only within volatile protected memory and only for a duration needed to support an authorized reveal or transmission event.

In some embodiments, the multi-factor biometric authentication system is configurable on a per-vault basis. Different vaults may require different biometric combinations, match thresholds, liveness tests, output restrictions, or escalation rules. The system may support configurable fingerprint sensitivity thresholds, ocular or facial recognition confidence thresholds, optional thermal checks, optional behavioral analysis, or combinations thereof. The system may further implement dynamic escalation of required authentication factors based on transaction sensitivity, credential classification, policy changes, or real-time risk analysis.

In some embodiments, the credential access control engine performs authentication confidence scoring, credential classification analysis, time-based access evaluation, repeated access prevention, unattended access prevention, and target-specific output control. The engine may deny access, require step-up authentication, authorize a limited operation, authorize a full reveal, authorize only a one-time token, or combinations thereof based on policy and context. In some embodiments, each reveal or output event requires fresh biometric confirmation even when the device remains physically present with a previously authenticated user.

In some embodiments, the ephemeral reveal engine acts as a timed, self-clearing credential display mechanism. Credential display is limited to a predefined duration, after which the display is automatically terminated. Working memory, display buffers, caches, or temporary registers containing credential content are cleared immediately after the reveal interval. The engine enforces automatic system lockout after the reveal event so that full re-authentication is required for any later access. In some embodiments, credential caching, screenshot capture, clipboard retention, or persistence in system logs is prohibited by design. In some embodiments, a tamper-interrupt mechanism immediately terminates the reveal and records an event when the system detects a capture attempt, enclosure opening, interface misuse, or another policy violation.

In some embodiments, the controlled output subsystem restricts credential transmission to a single defined channel per access event. A visual token output mode generates a one-time encoded representation usable for local device fill, credential ingestion, or transaction authorization. An HID emulation mode temporarily causes the device to emulate a keyboard or other input peripheral so that a credential or code is transmitted once to a target system and then output capability is disabled. Output channel selection is itself authenticated, and simultaneous multi-channel output is prohibited.

In some embodiments, the duress and decoy response system uses an alternate authentication pattern to silently trigger release of a decoy vault rather than genuine protected credentials. The decoy vault may contain plausible but non-functional credentials, substitute accounts, or other designated decoy data. The real credentials remain inaccessible, and the device does not externally signal to an observer that the decoy state has been activated. In some embodiments, the event is logged internally with device and biometric context. In some embodiments, a covert delayed communication may notify a trusted party after a configurable delay.

In some embodiments, the offline recovery and legacy authorization module supports recovery through a physical recovery artifact protected by a second authentication layer. Legacy access may be triggered after a defined inactivity interval, estate-planning condition, administrative event, or multi-party approval process. In some embodiments, recovery or legacy access events generate full audit trails and require confirmation by multiple authorized parties to reduce abuse risk.

In some embodiments, a zero-knowledge implementation is used in which the secure hardware device 700 proves that a user satisfied a required biometric threshold without transmitting a raw biometric image, a raw biometric waveform, or a reconstructable biometric template to a relying service. For example, the device may generate a commitment to a locally computed authentication result and respond to a verifier challenge with a proof that the commitment corresponds to a successful match against an enrolled protected template under an approved policy. In some embodiments, the proof is bound to a specific transaction request, session, target application, device attestation state, or time window so that the proof cannot be replayed for another purpose.

In some embodiments, a federated learning implementation is used in which multiple secure hardware devices or institution-managed terminals update local biometric or anomaly-detection models based on local authentication outcomes. Each device computes local model deltas or gradients and transmits only encrypted, masked, or securely aggregated update information to a coordination service. The coordination service combines the updates to generate a revised model without receiving raw biometric samples. In some embodiments, the revised model is signed and distributed only to attested devices operating approved firmware and approved policy sets.

In some embodiments, a consent and deletion implementation is used in which each enrolled user is associated with a consent profile specifying which biometric modalities may be used, for what purposes, in which jurisdictions, for what duration, and under which recovery or delegation conditions. A deletion workflow may be triggered by user request, policy expiration, jurisdictional rule, administrative action, or account closure. In response, the system invalidates template references, deletes local encrypted template material, issues deletion instructions to any remote encrypted fragment stores, updates the audit trail to indicate completion status, and prevents future authentication using the deleted template set unless re-enrollment occurs.

In some embodiments, a smart-contract implementation is used in which successful biometric authentication by the secure hardware device 700 unlocks execution authority for a blockchain-based smart contract. The device may generate a signed authorization payload or transaction signature only after satisfying a vault policy, a biometric threshold, and any applicable liveness or multi-party requirements. In some embodiments, the signed authorization payload includes contract-specific parameters, wallet identifiers, nonce values, expiration values, and device attestation data so that the resulting smart-contract action is bound to the approved context and cannot be reused in another transaction. In some embodiments, the smart-contract workflow supports release of escrow, transfer of tokenized assets, invocation of governance rights, approval of treasury actions, or activation of decentralized identity assertions.

### Additional Notes

The above detailed description includes references to the accompanying drawings, which form a part of the detailed description. The drawings show, by way of illustration, specific embodiments that may be practiced. These embodiments are also referred to herein as examples. Such examples may include elements in addition to those shown or described. However, the present inventors also contemplate examples in which only those elements shown or described are provided. Moreover, the present inventors also contemplate examples using any combination or permutation of those elements shown or described, or one or more aspects thereof, either with respect to a particular example or with respect to other examples shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples or one or more aspects thereof may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A system comprising: a secure environment configured to store protected data; an authentication module operatively coupled to the secure environment, the authentication module configured to receive an authentication input and verify the authentication input against a stored credential profile; a credential access control engine operatively coupled to the authentication module and configured to conditionally grant access to the protected data based on a result of the verification; and a credential release module operatively coupled to the secure environment and the credential access control engine, the credential release module configured to release the protected data upon receiving an affirmative access grant from the credential access control engine, wherein the credential release module is further configured to release the protected data using a time-limited display operation or a single-use transmission operation that prevents persistent storage of the protected data after release.

2. The system of claim 1, wherein the secure environment comprises a hardware-isolated secure enclave storage module configured to store the protected data in encrypted form.

3. The system of claim 1, wherein the authentication module comprises a biometric fusion processor configured to combine authentication evidence from a plurality of biometric modalities to generate a unified authentication decision.

4. The system of claim 1, wherein the credential access control engine is configured to select a security tier based on a transaction value, credential classification, requested operation type, time-based rule, geolocation, device state, or combinations thereof.

5. The system of claim 1, wherein the credential release module comprises an ephemeral reveal engine configured to display the protected data for a predefined duration, terminate the display upon expiration of the predefined duration, clear working memory associated with the protected data, and require re-authentication before a subsequent access event.

6. The system of claim 1, wherein the credential release module comprises a controlled output subsystem configured to selectively enable only one output channel per access event.

7. The system of claim 1, further comprising a duress response subsystem configured to detect an alternate authentication pattern and, in response, provide access to a decoy credential set while preventing access to a genuine credential set.

8. The system of claim 1, wherein the authentication module is configured to verify identity without transmitting raw biometric data to a relying system, and wherein the system is configured to generate a zero-knowledge proof or a commitment-based proof that a required authentication threshold has been satisfied.

9. A method comprising: storing protected data within a secure environment; receiving an authentication input using an authentication module; verifying the authentication input against a stored credential profile; determining, using a credential access control engine, whether access to the protected data should be granted based on a result of the verification; and releasing the protected data upon an affirmative access grant using a time-limited display operation or a single-use transmission operation.

10. The method of claim 9, wherein receiving the authentication input comprises receiving biometric data selected from fingerprint data, facial data, iris data, retinal data, ocular data, voice data, palm vein data, hand geometry data, behavioral biometric data, heartbeat-derived data, electrocardiogram-derived data, thermal biometric data, or combinations thereof.

11. The method of claim 9, further comprising combining authentication evidence from a plurality of biometric modalities to generate a unified authentication decision.

12. The method of claim 9, further comprising selecting a security tier based on a transaction value, credential classification, requested operation type, time-based rule, geolocation, device state, or combinations thereof.

13. The method of claim 9, wherein releasing the protected data comprises displaying the protected data for a predefined duration and clearing working memory associated with the protected data after expiration of the predefined duration.

14. The method of claim 9, wherein releasing the protected data comprises generating a one-time visual token or performing a one-time human interface device transmission.

15. A non-transitory computer-readable medium storing instructions that, when executed by at least one processor, cause the at least one processor to perform operations comprising: storing protected data within a secure environment; receiving an authentication input using an authentication module; verifying the authentication input against a stored credential profile; determining whether access to the protected data should be granted based on a result of the verification; and releasing the protected data upon an affirmative access grant using a time-limited display operation or a single-use transmission operation.

16. The non-transitory computer-readable medium of claim 15, the operations further comprising combining authentication evidence from a plurality of biometric modalities to generate a unified authentication decision.

17. The non-transitory computer-readable medium of claim 15, the operations further comprising selecting a security tier based on a transaction value, credential classification, requested operation type, time-based rule, geolocation, device state, or combinations thereof.

18. The non-transitory computer-readable medium of claim 15, the operations further comprising generating a one-time visual token or performing a one-time human interface device transmission as part of releasing the protected data.

19. The non-transitory computer-readable medium of claim 15, the operations further comprising generating a zero-knowledge proof or a commitment-based proof that a required authentication threshold has been satisfied without transmitting raw biometric data to a relying system.

20. The non-transitory computer-readable medium of claim 15, the operations further comprising authorizing execution of a smart contract, blockchain transaction, escrow release, tokenized identity action, or decentralized identity assertion only after successful biometric authentication.
